(19) United States
(12) Patent Application Publication
(10) Pub. No.: US 2011/0068767 A1
(43) Pub. Date: Mar. 24, 2011

(54) SUB-VOLT BANDGAP VOLTAGE REFERENCE WITH BUFFERED CTAT BIAS

(75) Inventor: Scott Douglas Carper, San Jose, CA (US)

(73) Assignee: INTERSIL AMERICAS INC., Milpitas, CA (US)

(21) Appl. No.: 12/953,394

(22) Filed: Nov. 23, 2010

Related U.S. Application Data
(63) Continuation of application No. 12/350,899, filed on Jan. 8, 2009, now Pat. No. 7,863,884.
(60) Provisional application No. 61/020,133, filed on Jan. 9, 2008.

(51) Int. Cl. G05F 3/16

(52) U.S. Cl. 323/313

(57) ABSTRACT

Circuits, methods, and apparatus that provide voltage references having a temperature independent output voltage that is less then the bandgap of silicon. The temperature coefficient and absolute voltage can be independently adjusted. One example generates two voltages, the first of which is proportional-to-absolute temperature and the second of which is complementary-to-absolute temperature. These voltages are placed across a first resistor. The first resistor is further connected to a second resistor to form a resistor divider. The resistor divider provides a reduced voltage that is below that bandgap of silicon. The temperature coefficient of the reference voltage provided by the resistor divider can be set by adjusting the first resistor. The absolute voltage provided can be set by adjusting the second resistor.

### CROSS-REFERENCES TO RELATED APPLICATIONS

This application is a continuation of U.S. application Ser. No. 12/350,899, (the '899 application), filed Jan. 8, 2009, which claims the benefit of U.S. provisional patent application No. 61/020,133, (the '133 application) filed Jan. 9, 2008, which is hereby incorporated by reference.

### BACKGROUND

Bandgap voltage references are one of the main building blocks used in electronic circuits. Bandgap voltage references may be used in a myriad of applications, including cell phones, MP3 players, personal digital assistants, cameras, video recorders, and others.

Simply stated, a bandgap voltage reference receives a power supply and generates an output voltage. The bandgap voltage reference may be designed to provide an output voltage that is stable over temperature, or it may be designed to provide an output voltage that varies over temperature, for example to compensate for a change caused by temperature in another circuit or circuit element.

The output of the reference voltage may be used for a number of purposes. For example, a reference voltage output that is stable over temperature, that is, has a low temperature coefficient, can be placed across an external resistor to generate a current that is stable over temperature. Also, a reference voltage output can be used along with a regulator circuit to provide a regulated power supply.

Conventional bandgap circuits provide output voltages on the order of the bandgap of silicon or higher, that is, they provide output voltages that are at or exceed approximately 1.26 volts, though this value depends on the specific processing technology used. However, many modern circuits require a voltage less than the bandgap of silicon. For example, many newer technologies provide devices that have excessive leakage when their drain voltages are higher than approximately 1 volt. Also, lower voltages are often used where it is particularly desirable to save power. Another drawback of conventional circuits is that their temperature characteristics cannot be adjusted without changing their output voltage.

Thus, what is needed are circuits, methods, and apparatus that provide bandgap voltage references having output voltages less than the bandgap of silicon. It is also desirable that the output voltage and temperature coefficient be independently adjustable.

### SUMMARY

Accordingly, embodiments of the present invention provide circuits, methods, and apparatus that provide voltage references having a temperature independent output voltage that is 10 less than the bandgap of silicon. The temperature coefficient and absolute voltage of the voltage reference output can be independently adjusted.

A specific embodiment of the present invention generates two voltage sources, one of which is proportional-to-absolute temperature (PTAT), the other of which is complementary-to-absolute temperature (CTAT). These voltages are placed across a first resistor. The first resistor is further connected to a second resistor to form a resistor divider. The resistor divider provides a reduced voltage that is below that bandgap of silicon.

In this specific embodiment of the present invention, the temperature coefficient of the reference voltage provided by the resistor divider can be set by adjusting the first resistor. The absolute voltage provided can be set by adjusting the second resistor.

Various embodiments of the present invention may incorporate one or more of these and the other features described herein. A better understanding of the nature and advantages of the present invention may be gained by reference to the following detailed description and the accompanying drawings.

### BRIEF DESCRIPTION OF THE DRAWINGS

FIG. 1 is a symbolic representation of a bandgap voltage reference that is improved by the incorporation of embodiments of the present invention;

FIG. 2 is a block diagram of an electronic system that may be improved by the incorporation of an embodiment of the present invention;

FIG. 3 is a simplified schematic of a bandgap voltage reference according to an embodiment of the present invention;

FIG. 4 is a flowchart of a method of generating a bandgap voltage reference according to an embodiment of the present invention;

FIG. 5 is a schematic of a bandgap voltage reference according to an embodiment of the present invention; and

FIG. 6 is a flowchart illustrating another method of generating a bandgap voltage according to an embodiment of the present invention.

### DESCRIPTION OF EXEMPLARY EMBODIMENTS

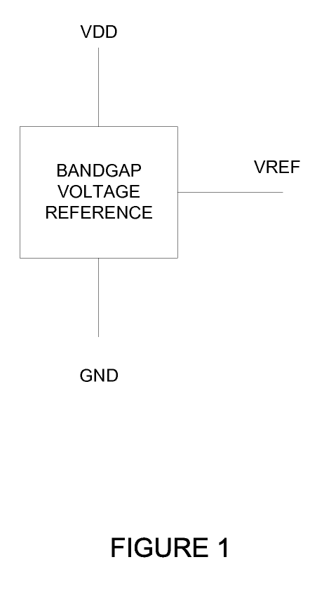

FIG. 1 is a symbolic representation of a bandgap voltage reference that is improved by the incorporation of embodiments of the present invention. The bandgap voltage reference receives a power supply and generates an output voltage Vref. The power supply may be a positive voltage, shown here as VDD, and ground. Alternately, ground and a negative voltage may be provided. In still other embodiments of the present invention, positive and negative voltages, or positive, negative voltages along with ground may be received. As a result, the output voltage provided may be above, or below, ground.

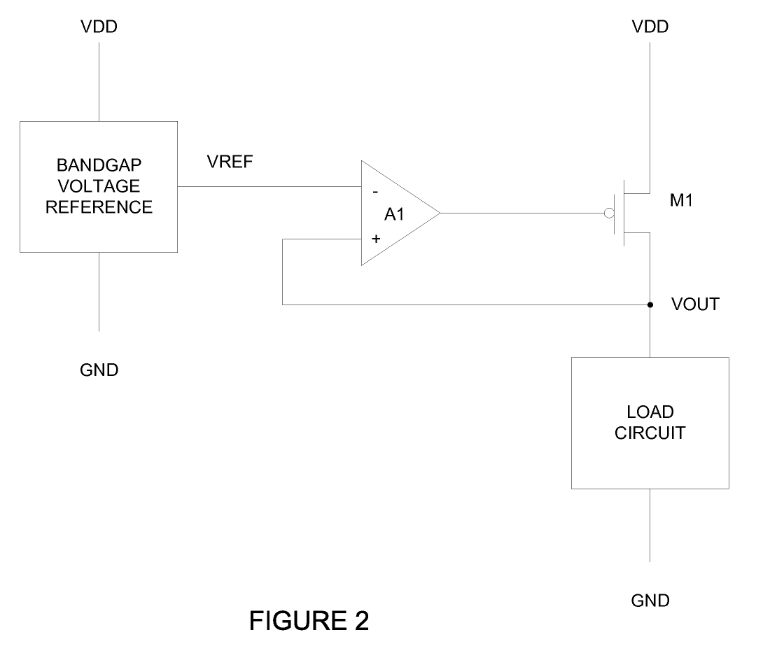

FIG. 2 is a block diagram of an electronic system that maybe improved by the incorporation of an embodiment of the present invention. This figure includes a bandgap voltage reference, amplifier A1, power transistor M1, and a load circuit.

The bandgap voltage reference provides an output Vref, which is received by an inverting input of the amplifier A1. The output of amplifier A1 drives power transistor M1. Power transistor M1 provides current to the load circuit. The resulting regulated power supply of Vout at the load circuit is fed back to amplifier A1, where it is compared to the reference voltage Vref. Differences between these two voltages drive the output of amplifier A1 such that these two voltages are equalized.

For example, if Vout is higher than desired, the output of amplifier A1 increases. This, in turn reduces the current provided by M1, thus lowering the regulated output voltage Vout. Similarly, if Vout is lower than desired, the output of amplifier A1 decreases, turning M1 on harder, thereby increasing its current. This results in an increase in the voltage Vout.

It is often desirable that the regulated voltage Vout be stable over temperature. That is, it is desirable that the regulated voltage Vout has a low temperature coefficient. In some circuits, it is also desirable that the regulated voltage Vout be less than the bandgap of silicon. Accordingly, embodiments of the present invention provide a bandgap voltage reference that provides a reference voltage output that is less than the bandgap of silicon and has a low temperature coefficient. In other embodiments of the present invention, the temperature coefficient may be set to compensate for temperature effects seen elsewhere. For example, it may be desirable that at high-temperature the load circuit receives a higher regulated voltage. Alternately, it may be desirable that at high temperatures the load circuit receives a lower regulated voltage. Accordingly, the bandgap voltage reference temperature coefficient provided by a bandgap voltage reference according to an embodiment of the present invention can be adjusted.

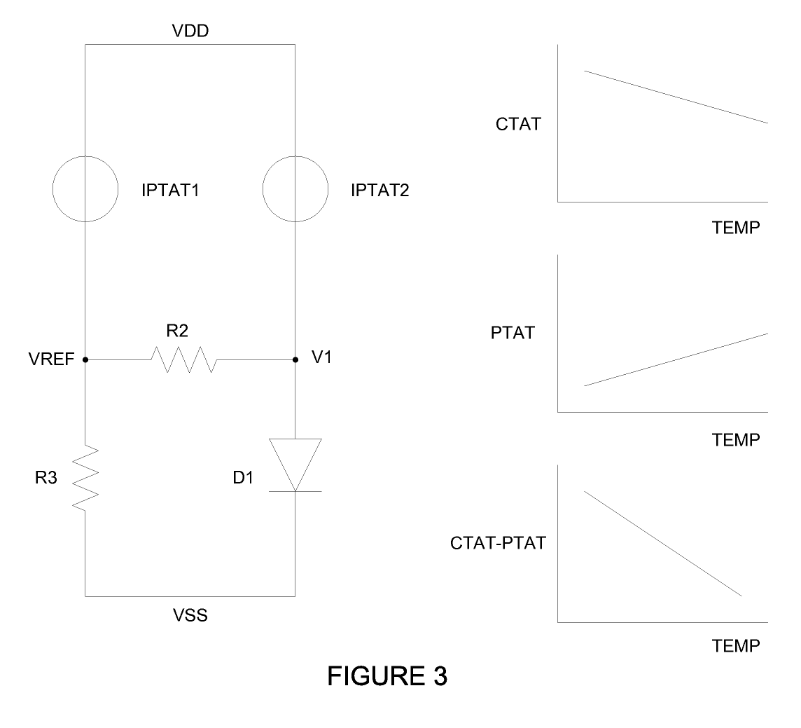

FIG. 3 is a simplified schematic of an embodiment of the present invention. This figure includes two current sources to provide currents that are proportional-to-absolute temperature. Also included are resistors R2 and R3, and diode D1.

Applying the principles of superposition and removing R2, the current sources generate a voltage Vref across R3 that is proportional-to-absolute temperature, and a voltage V1 across diode D1. The voltage V1 across diode D1 decreases as the temperature increases. Accordingly, the voltage V1 across diode D1 is complementary-to-absolute temperature.

With R2 included, a voltage that is the difference between a first voltage that is complementary-to-absolute temperature and a second voltage that is proportional-to-absolute temperature is placed across resistor R2. This in turn generates a current that strongly decreases as temperature increases. This is shown in the included graphs.

The proportional-to-absolute temperature current IPTATI is combined with the current in R2. The magnitude of the resistor R2, and thus the resulting current through R2, can be adjusted such that Vref has a low temperature coefficient. Moreover, the output voltage Vref can be adjusted by changing the value of R3. In a specific embodiment of the present invention, R3 is a series of resistors, the series of resistors having switches at a number of intermediate nodes, where the output Vref is coupled to an intermediate node between two of the series of the resistors by one of the switches.

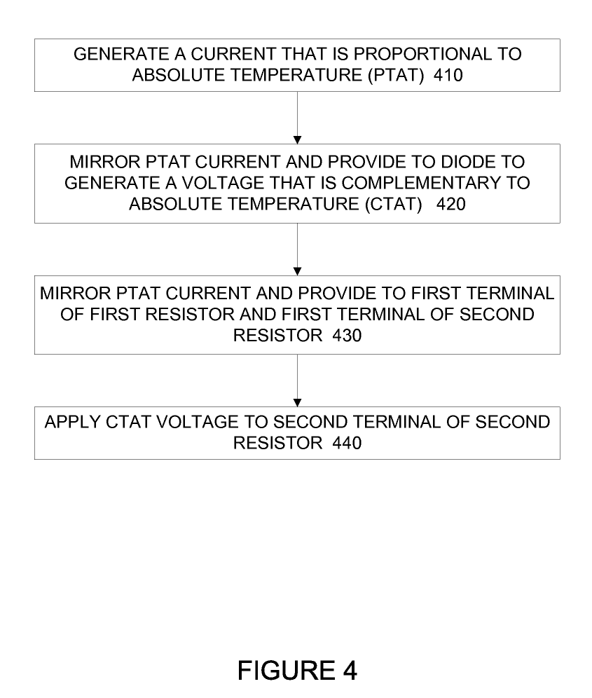

FIG. 4 is a flowchart of a method of generating a bandgap voltage reference according to an embodiment of the present invention. Specifically, in act 410, a current that is proportional-to-absolute temperature is generated. This current is mirrored and provided to a diode to generate a voltage that is complementary-to-absolute temperature in act 420.

In act 430, the proportional-to-absolute temperature current is mirrored again and provided to a first terminal of a first resistor and a first terminal of a second resistor. In act 440, the complementary-to-absolute temperature voltage is applied to a second terminal of the second resistor. A bandgap reference voltage is then available at the first terminal of the first resistor. The second resistor may be scaled to provide the desired temperature coefficient for the output voltage, while the first resistor may be scaled to adjust the absolute voltage of the bandgap reference voltage.

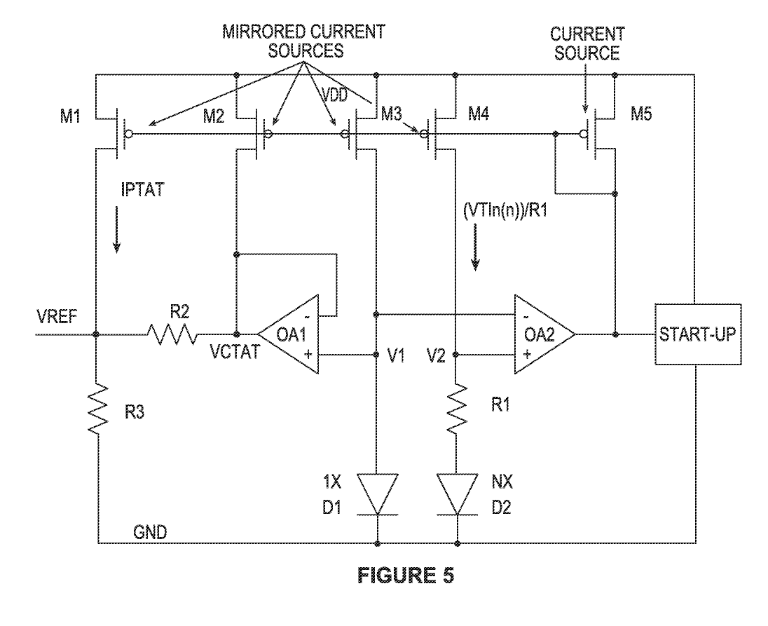

FIG. 5 is a schematic of a bandgap voltage reference according to an embodiment of the present invention. This figure includes proportional-to-absolute temperature current generating circuit including diodes D1 and D2, resistor R1, and amplifier OA2.

Amplifier OA2 generates a current through transistor M5, which is mirrored through transistors M2, M3, and M4. Transistors M2, M3, M4, and M5 may each be the same size, or they may have different sizes. In this example, they are p-channel devices, though in other embodiments they may be bipolar PNP transistors, multiple p-channel devices, or other devices. The current mirrored by M2 provides current for the output stage of amplifier OA1, which may thus have an open drain output stage. The current mirrored by transistor M3 is provided to diode D1, resulting in a voltage V1. Similarly, current in transistor M4 is provided to resistor R1 and diode D2, resulting in a voltage V2. Amplifier OA2 compares voltages V1 and V2 and adjusts the current in M5, and thereby the currents in transistors M3 and M4, such that voltages V1 and V2 are equal.

Diode D2 is a multiple of diode D1. As shown here, diode D2 is “N” times the size of diode D1. Typically, this is achieved by replicating a diode the size of diode D1 N number of times. For example, diode D2 may be made up of eight diodes, each the size of diode D1. In a specific embodiment of the present invention, the diodes are implemented using substrate PNPs, though in other embodiments of the present invention they may be other P-N junctions. Resistors R1, R2, and R3 may be polysilicon or other type of resistor.

As before, the resulting voltage V1 is complementary-to-absolute temperature. The voltage V1 is buffered by amplifier OA1 and provided to the resistor R2. In this example, amplifier OA1 acts as a voltage follower to prevent R2 from bleeding current from the diode D1.

Again, ignoring resistor R2, the voltage across resistor R3 is proportional-to-absolute temperature. This means the voltage across R3 would have a large temperature coefficient temperature coefficient. Accordingly, R2 is inserted and connected to the complementary-to-absolute temperature voltage provided by amplifier OA1. As before, this voltage has a large negative temperature coefficient. By adjusting R2, these temperature coefficients are canceled, resulting in an output voltage Vref having a low temperature coefficient. Moreover, resistor R3 may be adjusted to provide a desirable output voltage Vref.

Care should be taken in the design of bandgap voltage reference circuits to ensure that they properly start up when their power supply is turned on. For example, in the present circuit, if the current in transistor M5 is zero, the voltages V1 and V2 will both be zero and thus be equal. Though undesirable, this is a stable state. Accordingly, this specific embodiment of the 10 present invention employs a start-up circuit that provides an initial current in transistor M5 such that this undesirable state does not occur.

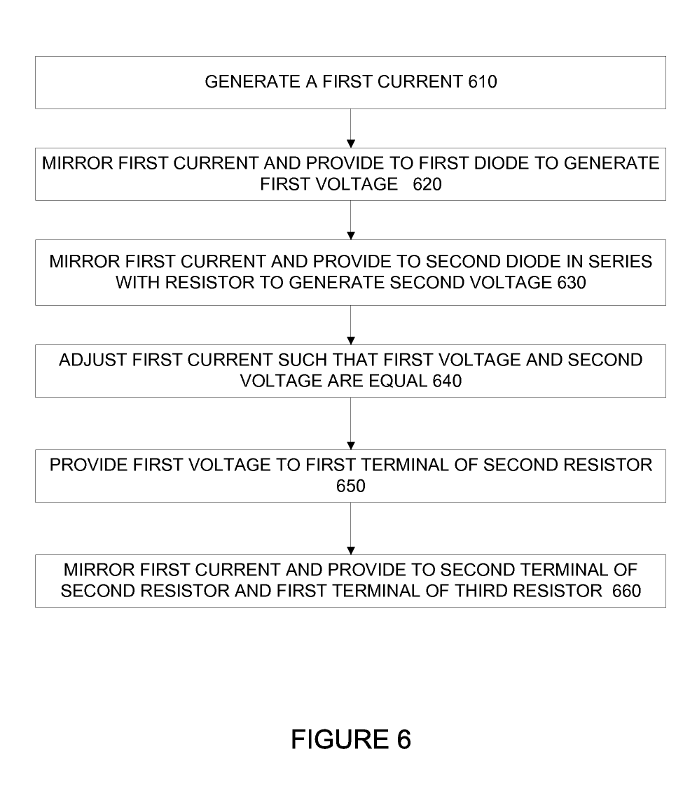

FIG. 6 is a flowchart illustrating another method of generating a bandgap voltage according to an embodiment of the present invention. In act 610, a first current is generated. In act 620, the first current is mirrored and provided to a first diode to generate a first voltage. The first current is mirrored and provided to a second diode that is in series with a resistor to generate a second voltage in act 630.

In act 640, the first current is adjusted such that the first voltage and the second voltages are equal. The first voltage is then provided to a first terminal of a second resistor in act 650. The first current is then mirrored and provided to a second terminal of the second resistor and a first terminal of the third resistor. The output voltage is then available at the first terminal of the third resistor.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

What is claimed is:

1. A method of generating a bandgap voltage reference, comprising:
generating a proportional-to-absolute temperature current;
mirroring the proportional-to-absolute temperature current and enabling a first current source;
coupling a first current from the first current source to a terminal of a diode;
generating a complementary-to-absolute temperature voltage at the terminal of the diode;
mirroring the proportional-to-absolute temperature current and enabling a second current source;
coupling a second current from the second current source to a first terminal of a first resistor and a first terminal of a second resistor;
coupling the complementary-to-absolute temperature voltage to a second terminal of the second resistor;
mirroring the proportional-to-absolute temperature current and enabling a third current source; and
coupling a third current from the third current source to the second terminal of the second resistor.

2. The method of claim 1, wherein the coupling the complementary-to-absolute temperature voltage to the second terminal of the second resistor further comprises:
coupling the complementary-to-absolute temperature voltage to an input of a voltage follower; and
coupling an output of the voltage follower to the second terminal of the second resistor.

3. The method of claim 1, wherein the coupling the complementary-to-absolute temperature voltage to the second terminal of the second resistor further comprises:
buffering the complementary-to-absolute temperature voltage; and
coupling the buffered complementary-to-absolute temperature voltage to the second terminal of the second resistor.

4. The method of claim 1, wherein the enabling the first current source, second current source, or third current source comprises enabling a P-channel transistor.

5. The method of claim 1, wherein the generating the complementary-to-absolute temperature voltage comprises generating the complementary-to-absolute temperature voltage across a substrate PNP device.

6. The method of claim 1, further comprising coupling a second terminal of the first resistor to circuit ground.

7. The method of claim 1, further comprising generating the bandgap voltage reference at the first terminal of the first resistor.

8. The method of claim 1, further comprising generating a reference voltage with a value less than a bandgap of silicon.

9. The method of claim 1, further comprising:
generating the bandgap voltage reference at the first terminal of the first resistor; and
coupling the bandgap voltage reference to a low-dropout regulator.

10. The method of claim 1, wherein the mirroring comprises mirroring the proportional-to absolute temperature current utilizing at least one P-channel Metal-Oxide Semiconductor (PMOS) device.

11. A method of generating a bandgap voltage reference, comprising:
generating a proportional-to-absolute temperature current;
mirroring the proportional-to-absolute temperature current and forming a first mirrored current;
coupling the first mirrored current to a terminal of a first diode;
generating a first voltage at the terminal of the first diode;
mirroring the proportional-to-absolute temperature current and forming a second mirrored current;
coupling the second mirrored current to a terminal of a second diode;
generating a second voltage at the terminal of the second diode;
comparing the first voltage to the second voltage;
responsive to the comparing, adjusting the proportional-to-absolute temperature current and substantially equalizing the first voltage and the second voltage;
coupling the first voltage to a first terminal of a first resistor;
mirroring the proportional-to-absolute temperature current and forming a third mirrored current; and
coupling the third mirrored current to a second terminal of the first resistor and a first terminal of a second resistor.

12. The method of claim 11, wherein the coupling the first voltage to the first terminal of the first resistor comprises:
buffering the first voltage; and
coupling the buffered first voltage to the first terminal of the first resistor.

13. The method of claim 11, wherein the coupling the first voltage to the first terminal of the first resistor comprises:
coupling a complementary-to-absolute temperature voltage to the first terminal of the first resistor.

14. The method of claim 11, wherein the coupling the first voltage to the first terminal of the first resistor comprises:
coupling the first voltage to an input of a voltage follower; and
coupling an output of the voltage follower to the first terminal of the first resistor.

15. The method of claim 11, wherein the comparing comprises:
coupling the first voltage to a first terminal of an amplifier;
coupling the second voltage to a second terminal of the amplifier; and
comparing the first voltage to the second voltage with the amplifier.

16. The method of claim 11, wherein the generating the second voltage comprises:
generating the second voltage across the second diode and a third resistor.

17. The method of claim 11, further comprising:
coupling a second terminal of the second resistor to circuit ground.

18. The method of claim 11, further comprising generating the bandgap voltage reference at the first terminal of the second resistor.

19. The method of claim 11, further comprising generating a reference voltage with a value less than a bandgap of silicon at the first terminal of the second resistor.

20. The method of claim 11, wherein the mirroring comprises mirroring the proportional-to-absolute temperature current utilizing a plurality of PMOS devices.
